(19) United States
(12) Patent Application Publication
(10) Pub. No.: US 2011/0242800 A1
(43) Pub. Date: Oct. 6, 2011

(54) Modular furnishing elements

(75) Inventors: Ezio Borghetto, Villorba (IT); Andrea Zorzi, Abano Terme (IT); Valter Amadio, Arcade (IT)

(73) Assignee: Ezio BORGHETTO

(21) Appl. No.: 13/064,468

(22) Filed: Mar. 28, 2011

(30) Foreign Application Priority Data
Mar. 31, 2010 (IT) TV2010A000050

(51) Int. Cl. F21S 8/00

(52) U.S. Cl. 362/147

(57) ABSTRACT

Modular furnishing elements constituted by a single piece or by a plurality of pieces, provided with a plurality of internal intrusions of air and, in a lower region, with an opaque region.

The transparent pieces are mutually adjacent so as to define at least one gap at which one or more ribbons with LEDs are embedded or associated.

The light, in passing through the piece, is refracted through the intrusions thus illuminating the pieces.

The present invention relates to modular furnishing elements.

### BACKGROUND OF THE INVENTION

Nowadays the use is known, in order to cover for example internal walls or other surfaces of residences, of tiles, which are laid directly onto an adapted layer of glue that has been previously associated with a wall by means of the application of appropriate spacers in order to define gaps which are then obstructed by means of the application of an adapted mortar.

In this way a decorated wall is obtained in which the decoration is provided exclusively by the coloration or motif upon the tile, and this decoration remains unaltered over time and is therefore always the same.

Thus if the user wants to change the aesthetic value of the wall, he or she is forced to remove the tiles and to reposition others in their place with the desired decoration.

Furthermore, coverings of a wall with tiles, especially if they are dark in coloration, also presupposes the definition of one or more lighting points in order to make the room brighter.

### SUMMARY OF THE INVENTION

The aim of the present invention is to solve the above-mentioned technical problems, eliminating the drawbacks in the cited known art, by devising a modular furnishing element that makes it possible to obtain walls by virtue of tiles the decoration of which can be modified without removing the tiles.

Within this aim, an object of the invention is to provide a modular furnishing element that makes it possible at the same time to liven up the environment in which the tiles are laid.

Another object of the invention is to make it possible to obtain a wall that has a high aesthetic level.

A further object of the invention is to obtain a modular furnishing element that is structurally simple, can be manufactured at low cost and can be made with the usual known systems.

This aim and these objects, as well as others which will become better evident hereinafter, are achieved by modular furnishing elements, characterized in that they are constituted by one or more pieces, flat or curved, transparent and made of glass, and provided with a plurality of internal intrusions of air between said one or more transparent glass pieces, there being defined at least one housing at which one or more LEDs or ribbons with LEDs are embedded or associated, the light of said LEDs being transmitted within the glass and refracted by said intrusions.

### BRIEF DESCRIPTION OF THE DRAWINGS

Further characteristics and advantages of the invention will become better apparent from the detailed description of a particular, but not exclusive, embodiment thereof, illustrated by way of non-limiting example in the accompanying drawings, wherein:

FIG. 1 is a partially cross-sectional perspective view of a modular panel structure and of a single tile;

FIG. 2 is a sectional view, taken along the line II-II of FIG. 1;

FIG. 3 is a sectional view, taken along the line III-III of FIG. 1;

FIG. 4 is a partially sectional view of a detail of a single tile;

FIG. 5 is a perspective side view of the application of a baseplate to the modular panel structure;

FIG. 6 is a view similar to the previous one of another embodiment of the modular panel structure;

FIG. 7 is a sectional view, taken along the line VII-VII of FIG. 6;

FIG. 8 is a view similar to that in FIG. 5 of another embodiment of the modular panel structure;

FIG. 9 is a sectional view, taken along the line IX-IX of FIG. 8;

FIG. 10 is a view similar to that in FIG. 5 of another embodiment of the modular panel structure;

FIG. 11 is a view similar to the previous one of another embodiment of the modular panel structure;

FIG. 12 shows the use of a transparent tube, in a similar view to that in FIG. 2;

FIG. 13 is a perspective view of the transparent tube shown in the previous Figure, with the ribbon of LEDs extracted;

FIGS. 15 to 18 are views of other embodiments for using transparent tubes.

### DESCRIPTION OF THE PREFERRED EMBODIMENTS

In the embodiments that follow, individual characteristics shown in relation to specific examples may in reality be interchanged with other, different characteristics, existing in other embodiments.

Moreover, it should be noted that anything found to be already known during the patenting process is understood not to be claimed and to be the subject of a disclaimer.

With reference to the figures, the reference numeral 1 generally designates a modular furnishing element which is constituted by one or more pieces 2, such as tiles made of transparent glass which have internally a plurality of intrusions 3, constituted by air bubbles; in a lower region, there can be a region 4 that is opaque to light.

The shape of such tiles can vary as widely as desired and thus they can have a flat or arc-like shape and, in plan view, a polygonal shape of the regular or irregular type.

The glass tiles 2 have a desired thickness, preferably of around 12 mm; the intrusions 3 of air also have variable dimensions and shapes and are present within the tile 2 in a uniform or random manner, the intrusions 3 being indicatively marked in the accompanying Figures with symbols constituted by triangles and dots for the purposes of example only.

These one or more pieces or tiles 2 can also have different thicknesses.

These one or more glass pieces or glass tiles 2 can also be transparent or opaque.

Preferably the tile 2 is provided by glass fusion with a first plate 5, advantageously with a second plate 6, with a third plate 7 and with a fourth plate 8 of glass, superimposed so that the air bubbles that are intrinsic in the glass are not lost and so that other air bubbles are formed during the embedding step.

The one or more pieces or tiles 2 can be obtained by fusion of a desired number of plates.

Alternatively, the one or more glass pieces 2 or glass tiles are provided not only with one plate of opaque white or black glass and the other plates transparent, but also with plates of glass that are all transparent and a coating (either by spreading or other treatment) on one side in order to make it opaque.

The first plate 5, which is made preferably of glass but which can also be substituted by a coating or other opaque material, optionally also constitutes the region 4 indicated previously.

The superimposition of the first, second, third and fourth plates 5, 6, 7, 8 thus leaves blades of air between them and during the fusion part of this air remains embedded in the glassy mass of the tile 2 in the form of bubbles which are spherical or oblong or otherwise shaped, so as to define the intrusions 3.

The first plate 5, opaque black in colour or in general of a non-transparent colour, constitutes the opaque region 4 against which the intrusions 3 stand out.

The first plate 5 can also be opaque white in colour if the second plate 6 is always of the type that is coloured but transparent.

These tiles 2 can be obtained by fusing the various different plates cut to measure, optionally in containment molds, or they can be obtained by fusing larger glass surfaces on which the individual tiles are then cut to size and are then optionally finished with the second firing at a low softening temperature.

Obviously different shapes can also be obtained, such as cylindrical elements, semicylindrical elements, curved according to one or more planes, optionally mutually interconnected by virtue of, for example, gluing.

Once the individual tiles have been obtained, these are used in order to obtain for example a wall or prepackaged panels 9, flat or curved, complete and ready for installation by fixing them solidly to, or hanging them on, a wall or self-supporting structures in order to obtain a dividing wall.

The number of pieces that constitute an individual furnishing element 1 can moreover vary as a function of the shape of the furnishing element that it is desired to produce.

When positioning tiles on a wall, such tiles are installed in such a way as to leave, perimetrically thereto, gaps or a housing 10; unlike traditional laying the glue is spread under the first plate 5 and not on the wall, preferably on part of the lower surface of the first plate 5 so that the tiles are laid without making the glue 11 pour into the gaps or housing 10.

It is therefore important that once the tiles 2 are laid, the gaps 10 are free from obstruction.

This is because one or more ribbons 12 provided with LEDs 13 are embedded or associated at the at least one series of contiguous gaps.

Alternatively, one or more transparent tubes 430 can be used, such as for example illustrated in FIG. 12.

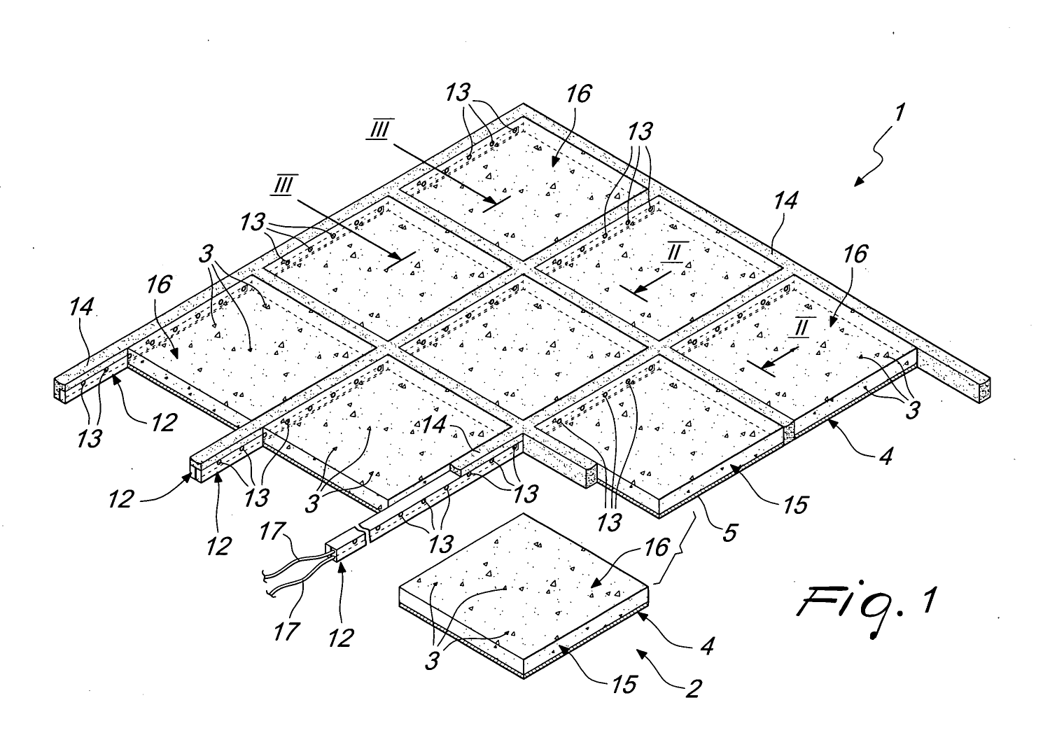

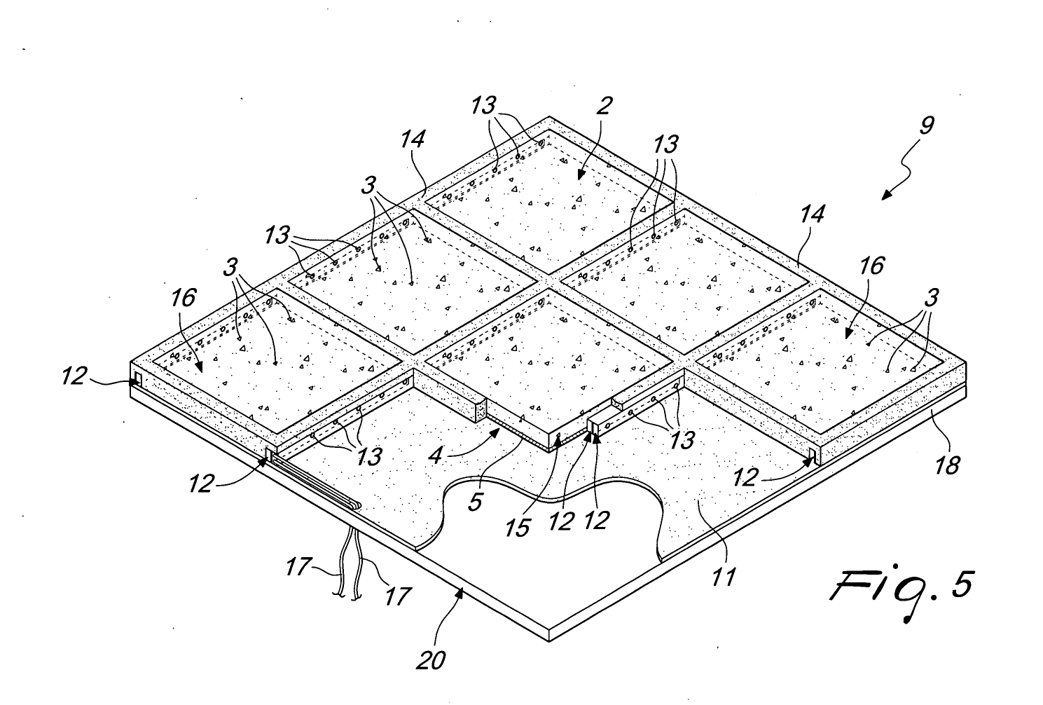

As shown in FIGS. 1 to 11, the ribbons 12 are laid within the gaps 10 and kept in position, with the LEDs 13 directed toward the adjacent tile, by means of the application of an adapted layer 14, for example of resin, or putty, or sealant, or a gasket, or a laminate made of metal or of flexible or rigid material, all transparent or opaque.

In the embodiment shown, ribbons 12 are used, each one having a row of LEDs 13, such ribbons being mutually paired in twos so as to obtain lighting on both sides.

Alternatively, on each gap or housing 10 a single ribbon 12 can be laid which is already provided with LEDs 13 on both sides.

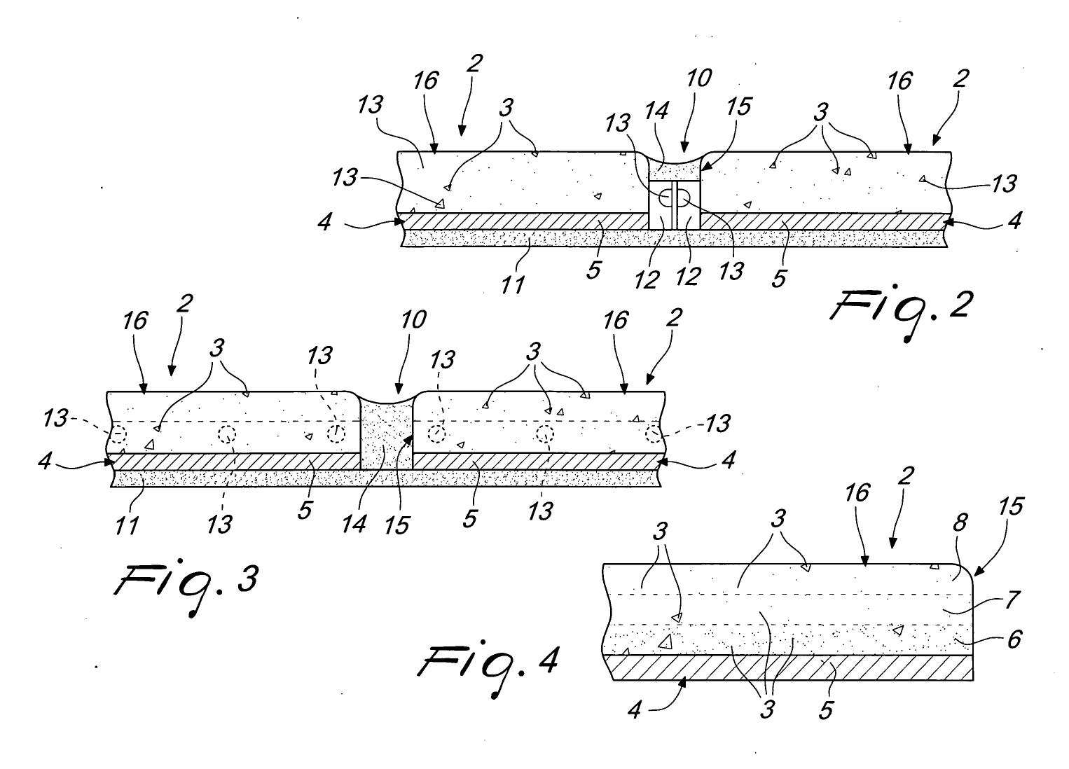

The ribbons 12, when they are paired as shown in FIG. 2, can also be positioned so as to stagger the positioning of the respective LEDs 13, so as to optimize or predefine the flow of light already at the laying step.

The positioning of the ribbons 12 at the gaps 10 must be done so that the LEDs 13 direct the beam of light against the adjacent lateral surface 15 of each tile 2; substantially the ribbons 12 must be laid approximately at right angles to the laying surface of the tile.

Alternatively, the ribbons 12 can also be laid approximately parallel to the laying surface of the tile.

The light generated by the LEDs thus crosses the glass plate, which acts as a conductor, and the light, by intercepting the intrusions 3 constituted by air bubbles, which are present in large numbers and are variously shaped and are diverse and varied in distribution, is mostly deviated towards the upper surface 16 of each tile 2.

In this way the glassy mass and the intrusions are highlighted, and appear luminescent so as to illuminate the entire tile and optionally the panel 9 thus obtaining an elegant aesthetic effect because the wall or panel is illuminated.

Subsequently, a sealant, such as an epoxy or polyurethane putty, can be superimposed at the layer 14 so as to further cover the ribbons 12 provided with the LEDs 13 and thus prevent the light from exiting at that point, instead forcing it to be poured entirely into the glassy mass.

The ribbons 12 can further have a desired number of LEDs per unit of length, the power supply being obtained by means of adapted cables 17 which are made to converge at suitable power supplies that are delocalized and connected to the electric mains of the residence.

Obviously adapted controls can be interposed for switching on and adjusting the light generated by the LEDs, both for simultaneously switching on and/or adjusting all of the LEDs, and also by sectors or areas or lines to obtain the desired aesthetic effect.

Even the depth of insertion of each ribbon 12 at the gap 10 will be the most appropriate as a function of the optimal transmission of light onto the lateral surface 15 of each tile 2 so that, for example, according to the power of the LEDs and to the thickness and the composition of the glass, the luminosity of the intrusions 3 is accentuated.

The ribbons 12 are preferably positioned in the horizontal gaps in order to improve an overall effect, but they can also be laid in the vertical gaps or partly in the horizontal gaps and partly in the vertical gaps.

The ribbons can be placed in a comb-like arrangement or also in closed rings.

The sealing of the gaps 10 in which the ribbons 12 are laid is of the removable type, so as to be optionally removed in order to carry out maintenance of the ribbons 12 should for example one or more LEDs 13 burn out.

Once the ribbons 12 are repositioned, it is then sufficient to reseal the gap 10.

If the transparent tubes 430 are used, it is possible to remove the ribbons 412 by simply extracting them from the tubes, so as to not require the removal of the sealant.

In this way, internal or external vertical surfaces can be made, as well as horizontal surfaces covered with water.

The gaps 10 not affected by the ribbons 12 can be filled with opaque sealant only or by a solid filler element made of silicone or transparent resin with an opaque putty on top.

Otherwise two different filling substances can be used, such as a transparent putty or silicone and an opaque putty on the upper part directed externally.

Alternatively the ribbons 12 of LEDs 13 can be inserted in a protective sheath or in one or more transparent tubes 430 and then laid in the gaps or in the housing 10.

In FIG. 5 a solution is shown which provides for the implementation of a panel 9 by means of the positioning, underneath the layer of glue 11, of a baseplate 18 which makes the panel 9 self-supporting.

In this case the cables 17 are made to pass through the layer of glue 11 and through the adapted opening 19 formed in the baseplate 18 preferably in proximity to a perimetric edge 20 thereof.

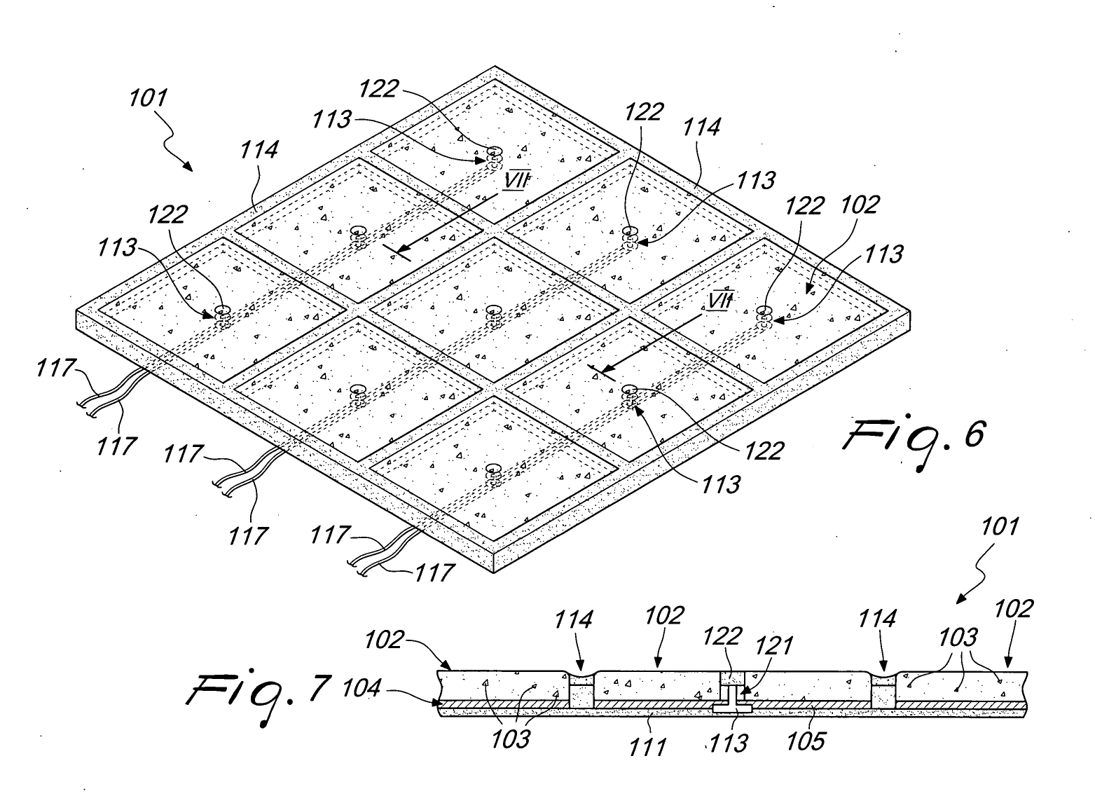

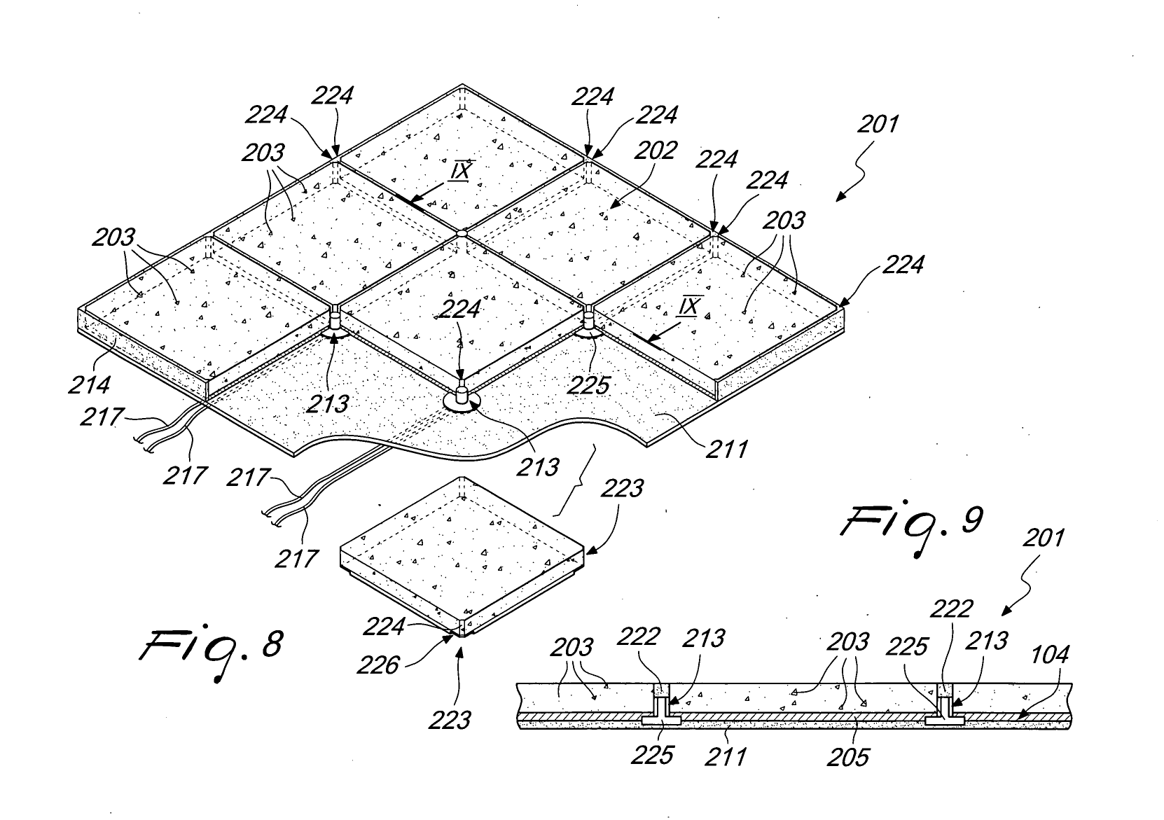

In FIGS. 6 and 7 a further embodiment of a furnishing element 101 is shown in which one or more tiles 102, provided internally with a plurality of intrusions 103, has, preferably in a central region thereof, a seat 121 that affects the first plate 105 constituting the opaque region 104 and which is adapted to allow the insertion therein of a single LED 113 which is kept stably in position by the presence of the layer of glue 111.

In this case there is a LED which has a light source that irradiates light through 360°, an adapted opaque screen 122 being positionable underneath it.

The rest of the gaps can be covered by a layer 114 of opaque finishing.

In this case the cables 117 connect an adapted row of LEDs 113, which are embedded in the layer of glue 111.

In FIGS. 8 and 9 a further embodiment of a furnishing element 201 is shown which is again constituted by a plurality of glass tiles 202 provided internally with a plurality of intrusions 203 of various shapes and distribution.

In the embodiment shown, one or more of the tiles 202 have, at one or more corners 223, adapted vertical slots 224, which accommodate a LED 213, which in turn has a base 225 partially embedded in a complementarily shaped bevel 226 provided on the first plate 205 constituting the opaque region 204 and is thus embedded in the layer of glue 211.

In this case too, above each LED 213 there is an opaque screen 222.

The rest of the gaps are covered by an adapted layer 214 of sealant.

In this case too, each LED 213 can be connected, by means of adapted cables 217, to other LEDs and respective power supplies.

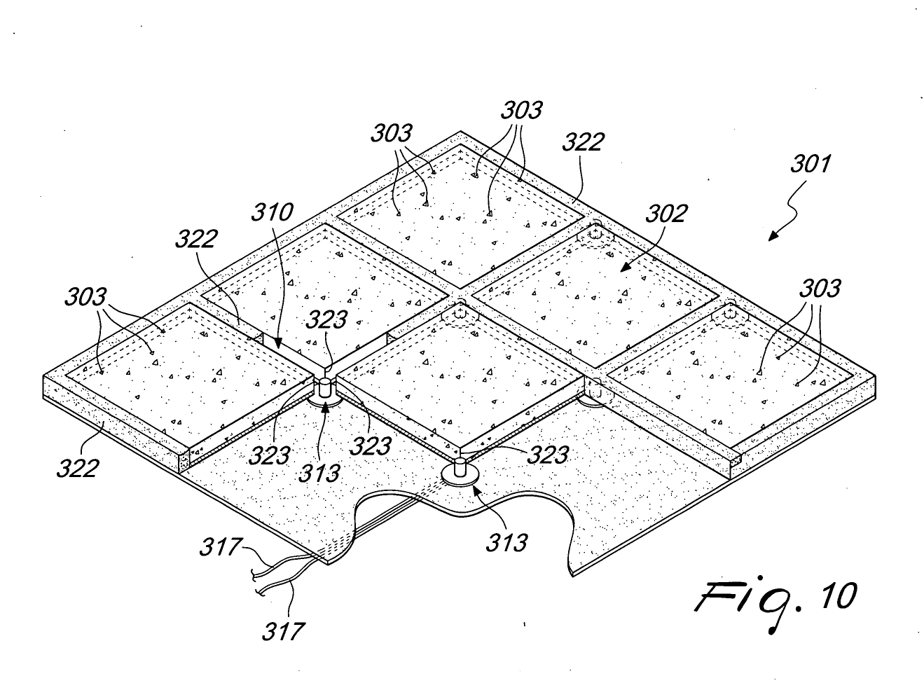

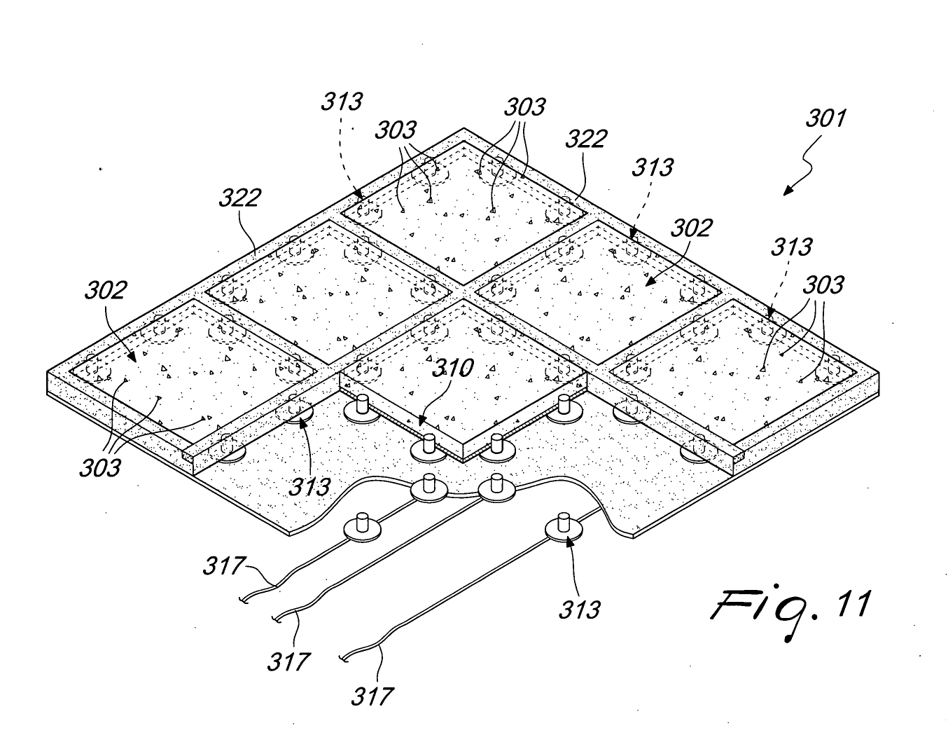

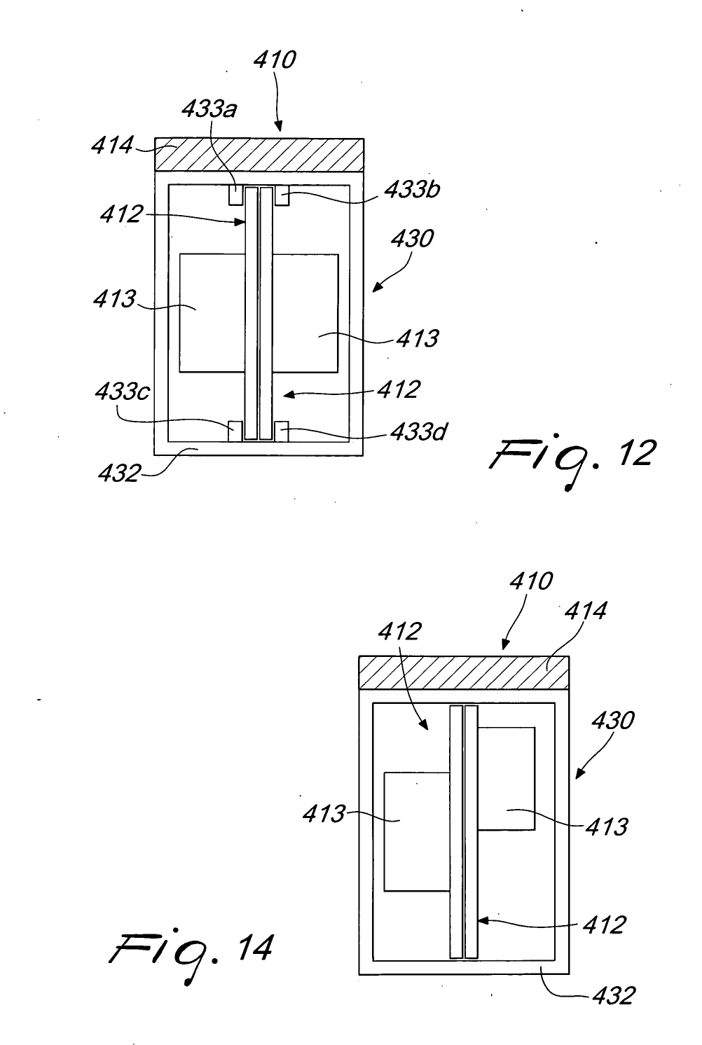

In FIGS. 10 and 11 a further embodiment of a furnishing element 301 is shown, which is constituted by a plurality of tiles 302 provided internally with a plurality of intrusions 303.

In this case the LEDs 313 are arranged at the gaps 310 in a region which is adjacent to the corners 323 of a plurality of tiles 302 and are subsequently covered in an upper region by an adapted opaque screen 322.

Alternatively, as shown in FIG. 11, the LEDs 313 can be arranged at the gaps 310 and then conveniently mutually connected by means of the cables 317.

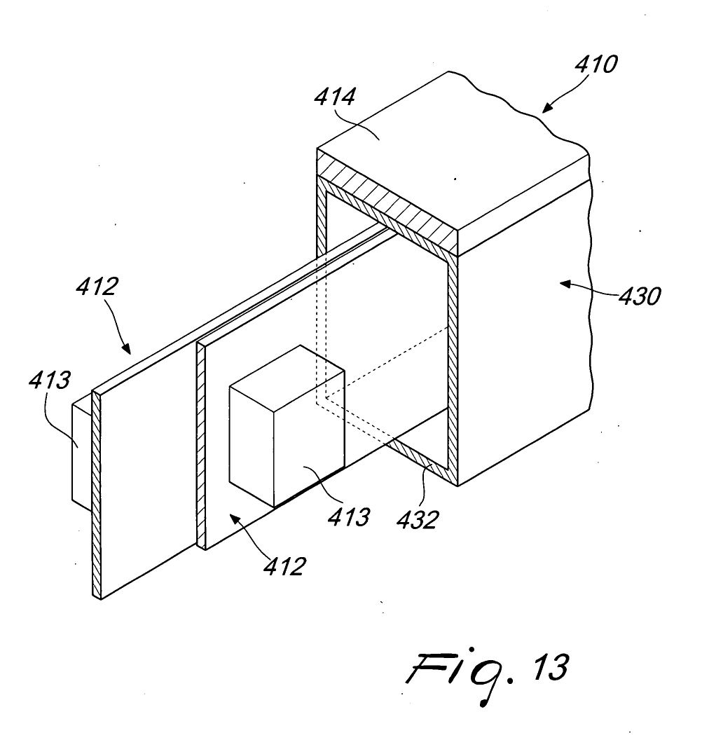

In FIGS. 12 to 18 other embodiments are shown which provide for the use of transparent tubes 430 of various shapes, and thus square or rectangular in plan view, with or without lateral wings 431a, 431b that extend externally or internally to each transparent tube.

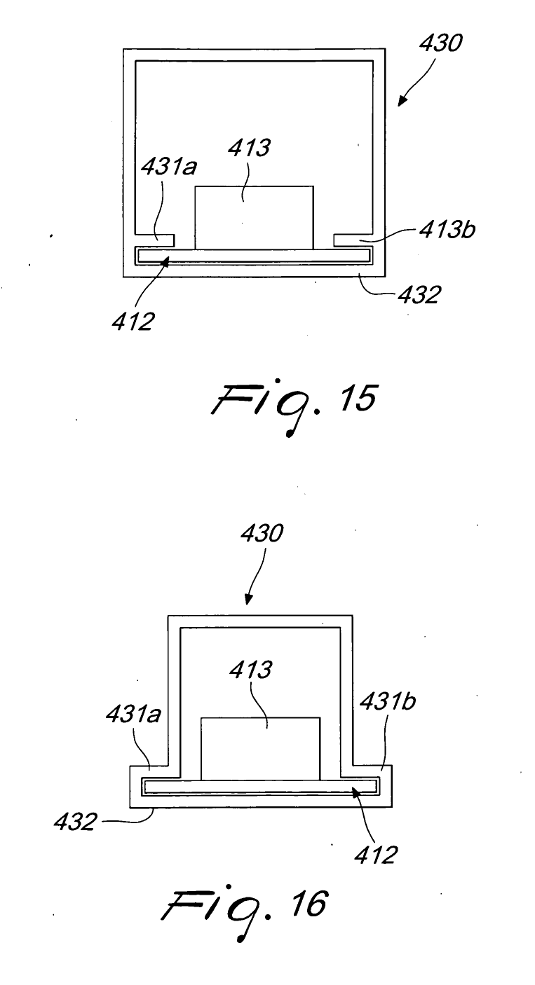

The lateral wings 431a, 431b define, preferably at the end 432 of the transparent tube 430, seats for the sliding and guided positioning, within the transparent tubes 430, of ribbons 412 provided with the LEDs 413, as shown in FIGS. 15 to 18.

These seats can also be obtained in proximity to another side of the transparent tubes 430.

Alternatively the guided positioning, within the transparent tubes 430, of the ribbons 412 provided with the LEDs 413 occurs by means of adapted pairs of beads 433a, 433b, 433c, 433d which protrude internally and approximately at the midpoint of the transparent tubes 430, as shown in FIG. 12.

Alternatively the guided positioning, within the transparent tubes 430, of the ribbons 412 provided with the LEDs 413 occurs by simple mechanical interference, as shown in FIG. 14.

The positioning of the LEDs 413 on the ribbons 412 can be symmetrical or non-symmetrical with respect to the center axis of each ribbon or with respect to an adjacent ribbon, as shown in FIG. 14.

At the gap or housing 410, on top of the transparent tubes 430, an adapted layer 414 is placed, for example of resin, or putty, or sealant, or a gasket, or a laminate made of metal or of flexible or rigid material, all transparent or opaque.

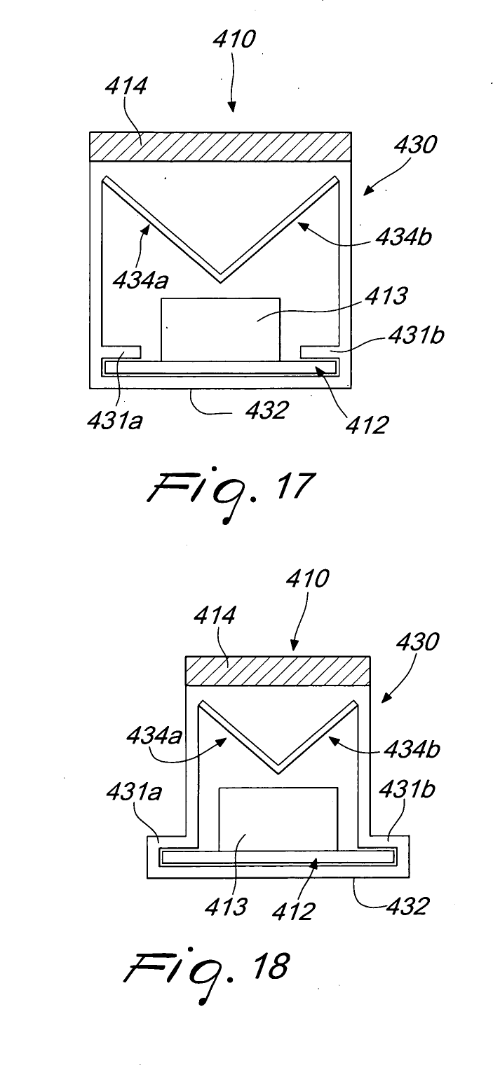

The transparent tubes 430 can internally have a cross-section that is different from the external cross-section, as shown in FIGS. 17 and 18 in which the presence can be seen, at the opposite end with respect to the end 432, of a pair of walls 434a, 434b which are inclined so as to form a ‘V’ shape with the vertex facing the end 432 and thus in the direction of the LEDs 413.

The vertex of the walls 434a, 434b is arranged approximately at the longitudinal center axis of the ribbons 412 of LEDs 413, while the walls 434a, 434b can be advantageously of the reflecting type, so as to increase the transmission of the light laterally to the transparent tubes 430.

In practice it has been found that the invention has achieved the above mentioned aim and objects, a furnishing element, such as a wall or a panel, having been obtained with glass tiles which, thanks to the presence of the LEDs, can be illuminated by virtue of the presence of the intrusions 3.

Obviously the materials used as well as the dimensions constituting the individual components of the elements according to the invention can be more relevant according to specific requirements.

The various different means for effecting certain different functions shall not in any way coexist only in the illustrated embodiment, but may be present per se in many embodiments, even if not illustrated.

The characteristics indicated as advantageous, advisable or similar may also be lacking or be substituted by equivalent characteristics.

The disclosures in Italian Patent Application No. TV2010A000050 from which this application claims priority are incorporated herein by reference.

What is claimed is:

1. Modular furnishing elements, constituted by one or more pieces, flat or curved, transparent and made of glass, and provided with a plurality of internal intrusions, between said one or more transparent glass pieces there being at least one gap or housing at which one or more LEDs or ribbons with LEDs are embedded or associated, the light of said LEDs being transmitted within the glass and refracted by said intrusions.

2. The elements according to claim 1, wherein said one or more pieces are constituted by a single tile or a plurality of tiles which are transparent and made of glass, flat or curved in shape and provided, in a lower region, with an optional opaque region, said plurality of tiles being mutually adjacent so as to form at least one housing or gap, said one or more LEDs being associated at the walls or corners or internally said tile.

3. The elements according to claim 2, wherein said one or more tiles or said one or more transparent glass pieces have internally a plurality of intrusions, constituted by air bubbles, and, in a lower region, an optional region which is opaque to light, said one or more tiles having a flat or arc-like shape and having, in plan view, a polygonal shape of the regular or irregular type.

4. The elements according to claim 3, wherein said one or more pieces or said one or more tiles are provided by glass fusion with one or more glass plates, said first plate being made of glass or substituted by a coating or other opaque material.

5. The elements according to claim 4, wherein said plates are superimposed so that the air bubbles that are intrinsic in the glass are not lost and so that other air bubbles are formed during the embedding step.

6. The elements according to claim 2, wherein said one or more pieces or said one or more tiles are provided by fusing one or more plates which are cut to size or are obtained by fusing larger glass surfaces on which said one or more pieces or said one or more tiles are then cut to size and are then finished with a second firing at a low softening temperature.

7. The elements according to claim 2, wherein in the positioning of said one or more pieces or of said tiles on a wall, said pieces or said tiles are installed so as to leave, perimetrically thereto, a housing or empty gaps at which said one or more ribbons provided with LEDs, or one or more transparent tubes inside which said LEDs or said ribbons can be positioned, are embedded or associated.

8. The elements according to claim 1, wherein said ribbons are arranged within said gaps or within said one or more transparent tubes and are kept in position, with said LEDs directed toward or away from the adjacent tile, by means of the application of a layer of material or by means of special supports or by mechanical interference.

9. The elements according to claim 1, wherein one or two of said ribbons are used for each gap or housing and can be mutually paired, each having a row of LEDs to obtain lighting on at least one of the sides of said gap or housing.

10. The elements according to claim 7, wherein one of said ribbons provided with said LEDs is used for each housing or gap or for each transparent tube, on one or both sides, in a paired or staggered position.

11. The elements according to claim 8, wherein a sealant, such as an epoxy or polyurethane putty, is superimposed at said layer and is adapted to cover said ribbons provided with the LEDs and to pour the light entirely into the glassy mass.

12. The elements according to claim 11, wherein sealing of said gaps or housing in which said ribbons are arranged is of the removable type, said ribbons being inserted in a protective sheath or in said one or more transparent tubes and then installed in said gaps or housing.

13. The elements according to claim 4, wherein one or more of said tiles or pieces has, in a central region, at least one seat, which affects at least said first plate and is adapted to accommodate said at least one single LED, stably maintained in position by the presence of a layer of glue, an adapted opaque screen being positionable below said at least one single LED.

14. The elements according to claim 4, wherein said plurality of one or more glass pieces or tiles, which have, at said one or more corners, vertical slots, which accommodate at least one LED, which has a base partially embedded in a complementarily shaped bevel provided on said first plate constituting said opaque region and is thus embedded in said layer of glue.

15. The elements according to claim 2, wherein said LEDs are arranged at said gaps or housing in a region which is adjacent to the corners of a plurality of pieces or tiles and are subsequently covered in an upper region by an opaque screen.

16. The elements according to claim 1, wherein said LEDs are arranged at the gaps or housing and then mutually connected by means of cables.

17. The elements according to claim 7, wherein said one or more transparent tubes have various shapes, such as square or rectangular in plan view, with or without lateral wings that extend externally or internally to each one of said transparent tubes, said lateral wings defining, at an end of said transparent tubes, seats for the sliding and guided positioning, within said transparent tubes, of said ribbons provided with said LEDs, said seats also being obtainable in proximity to another side of said transparent tubes.

18. The elements according to claim 17, wherein the guided positioning, within said transparent tubes, of said ribbons provided with said LEDs occurs by mechanical interference or by means of pairs of beads which protrude internally and approximately at a midpoint of said transparent tubes.

19. The elements according to claim 1, wherein the positioning of said LEDs on said ribbons is symmetrical or non-symmetrical with respect to a center axis of each ribbon or with respect to an adjacent ribbon.

20. The elements according to claim 7, wherein said transparent tubes internally have a cross-section that is different from the external cross-section, at an opposite end from said end a pair of walls being defined which are inclined so as to form a ‘V’ shape with a vertex facing in a direction of said LEDs, said vertex of said walls being arranged approximately at a longitudinal center axis of said ribbons of LEDs, while said walls are of the reflecting type, so as to increase the transmission of the light laterally to said transparent tubes.
